(19) United States
(12) Patent Application Publication
(10) Pub. No.: US 2010/0302620 A1
(43) Pub. Date: Dec. 2, 2010

(54) ELECTRONIC INK DISPLAY DEVICE AND MANUFACTURING METHOD THEREOF

(75) Inventors: Yasuyuki Makubo, Tokyo (JP); Yuichiro Ohmae, Tokyo (JP); Tomohiro Tsuji, Tokyo (JP); Tadao Nakamura, Tokyo (JP); Yoshikazu Hirota, Tokyo (JP)

Correspondence Address: LIU & LIU, 444 S. FLOWER STREET, SUITE 1750, LOS ANGELES, CA, 90071, US

(73) Assignee: TPO DISPLAYS CORP.

(21) Appl. No.: 11/568,038

(22) PCT Filed: Apr. 20, 2005
(86) PCT No.: PCT/IB2005/051284

§ 371 Date: Dec. 9, 2009

(30) Foreign Application Priority Data
Apr. 21, 2004 (JP) 2004-125669

(51) Int. Cl. G02F 1/167; B32B 37/02; B32B 38/00

(52) U.S. Cl. 359/296; 156/305; 156/275.5

(57) ABSTRACT

It is an object of the present invention to provide an electronic ink display device provided with a panel structure with excellent mechanical strength and humidity resistance. An electronic ink layer 13 is provided on a TFT substrate 10 through a lamination adhesive layer 12. The electronic ink layer 13 consists of micro capsules with electronic ink sealed therein contained in binders. A PET layer 16 including an ITO layer 15 is provided on the electronic ink layer 13. A TPA layer 11 is formed at one end of the electronic ink layer 13. A protect sheet 20 is provided on the PET layer 16 of FPL through a clear adhesive layer 17. The protect sheet 20 is provided with a humidity resistant barrier film 18 on one principal surface thereof through a clear adhesive layer 19.

### TECHNICAL FIELD

The present invention relates to an electronic ink display device and a manufacturing method thereof, and more particularly, to an electronic ink display device provided with a panel structure having excellent mechanical strength and humidity resistance and a manufacturing method thereof.

### BACKGROUND ART

In recent years, research and development on a display device using electronic ink is underway. This electronic ink consists of a mixture of a negatively charged black pigment chip and a positively charged white pigment chip in a micro capsule and when an electric field is applied, the black pigment chip and white pigment chip move, realizing a display in this way.

A display device using this electronic ink is normally manufactured by pasting a substrate having display pixels and a substrate including an electronic ink layer together and sealing ends of both substrate with a sealant.

### DISCLOSURE OF INVENTION

### Technical Problem

In the above-mentioned structure, since the substrate including the electronic ink layer is relatively thin, the mechanical strength of the electronic ink display device as a whole is weak. Furthermore, since the electronic ink layer is vulnerable to humidity, reliable sealing is required when the ends of the substrate are sealed.

The present invention has been implemented in view of the above-mentioned points and it is an object of the present invention to provide an electronic ink display device provided with a panel structure with excellent mechanical strength and humidity resistance.

### Technical Solution

The electronic ink display device according to the present invention comprises a first substrate having display pixels, a second substrate provided on the first substrate, which includes at least an electronic ink layer and a protect substrate provided on the second substrate, which is larger in size than the second substrate and extend from the second substrate, characterized in that the space between the protect substrate extending from the second substrate and the first substrate is filled with a sealant.

This configuration provided with the protect substrate can protect the second substrate including the electronic ink layer.

The sealant of the electronic ink display device of the present invention is preferably charged into the space between the protect substrate extending from the second substrate and the first substrate using capillarity.

This configuration allows the space between the extending protect substrate and first substrate to be tightly filled with the sealant.

The sealant of the electronic ink display device of the present invention is made of photo-setting resin and is preferably cured through irradiation of light into the space between the protect substrate and the first substrate from the end face side of the second substrate.

This configuration allows sufficient light to be irradiated onto the sealant charged tightly in the space between the extending protect substrate and first substrate and allows the sealant to be sufficiently cured. As a result, it is possible to realize a structure with excellent humidity resistance.

The method for manufacturing the electronic ink display device according to the present invention comprises a step of pasting a second substrate including at least an electronic ink layer to a first substrate having display pixels, a step of pasting a protect substrate, which is larger in size than the second substrate, to the second substrate so as to extend from the second substrate and a step of filling a space between the protect substrate extending from the second substrate and the first substrate with a sealant.

The step of filling with the sealant in the method for manufacturing the electronic ink display device according to the present invention is preferably realized in the space between the protect substrate extending from the second substrate and the first substrate using capillarity.

The step of filling with the sealant in the method for manufacturing the electronic ink display device according to the present invention preferably includes a step of curing the sealant through irradiation of light into the space between the protect substrate and the first substrate from the end face side of the second substrate.

### Advantageous Effects

The present invention can provide an electronic ink display device provided with a panel structure having excellent mechanical strength and humidity resistance.

### DESCRIPTION OF DRAWINGS

FIG. 1 illustrates a schematic structure of an electronic ink display device according to an embodiment of the present invention;

FIG. 2 illustrates an example of the schematic structure of FPLs of the electronic ink display device shown in FIG. 1;

FIG. 3 illustrates a method for manufacturing the electronic ink display device according to the embodiment of the present invention;

FIGS. 4(a), (b) illustrate the substrate pasting step in the method for manufacturing the electronic ink display device according to the embodiment of the present invention;

FIGS. 5(a), (b) illustrate the substrate pasting step in the method for manufacturing the electronic ink display device according to the embodiment of the present invention;

FIG. 6 illustrates the edge sealing step in the method for manufacturing the electronic ink display device according to the embodiment of the present invention;

FIG. 7 illustrates the edge sealing step in the method for manufacturing the electronic ink display device according to the embodiment of the present invention; and

FIG. 8 illustrates the edge sealing step in the method for manufacturing the electronic ink display device according to the embodiment of the present invention.

### BEST MODE

With reference now to the attached drawings, an embodiment of the present invention will be explained in detail below.

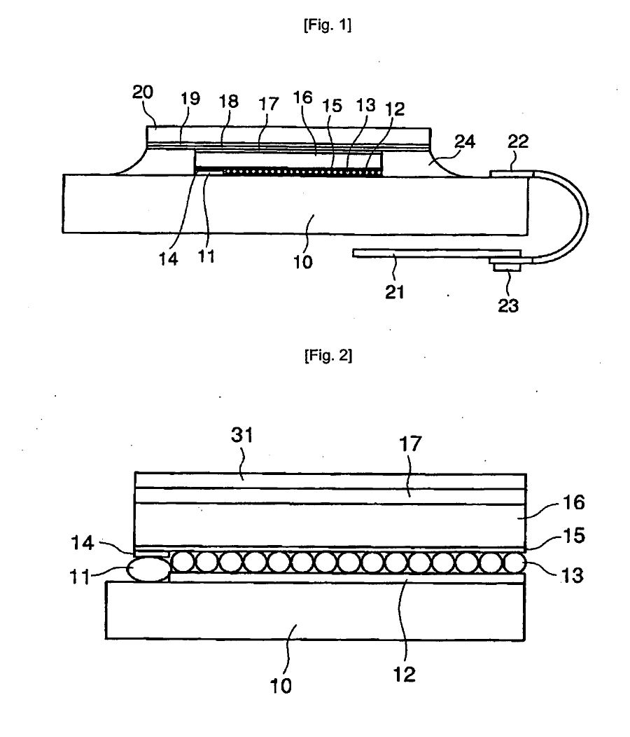

FIG. 1 illustrates a schematic structure of an electronic ink display device according to an embodiment of the present invention. FIG. 2 illustrates an example of the schematic structure of FPLs of the electronic ink display device shown in FIG. 1.

As shown in FIG. 1, the electronic ink display device of the present invention is mainly constructed of front plane laminates (FPL) 12 to 16 including an electronic ink layer provided on a TFT (Thin Film Transistor) substrate 10 having display pixels and a protect sheet 20 provided on the FPLs 12 to 16.

More specifically, an electronic ink layer 13 is provided on the TFT substrate 10 through the lamination adhesive layer 12. The electronic ink layer 13 consists of micro capsules with electronic ink sealed therein contained in binders. A PET layer 16 including an ITO layer 15 is provided on the electronic ink layer 13. Furthermore, a TPA (Top Plane Adhesive) layer 11 is formed at one end of the electronic ink layer 13. This TPA layer 11 is provided between the TFT substrate 10 and a connection pad 14 on the ITO layer 15 of the PET layer 16, provided in the area corresponding to the TPA layer 11. It is possible to use an Ag pad, etc., as the connection pad.

The thickness of the TFT substrate 10 is preferably approximately 200 to 700 μm. The thickness of the TPA layer 11 is preferably equal to or less than approximately 40 μm. The thickness of the lamination adhesive layer 12 is preferably equal to or less than approximately 20 μm. The thickness of the electronic ink layer 13 is preferably equal to or less than approximately 20 μm. The thickness of the connection pad 14 is determined according to the thickness of the TPA layer 11 and preferably equal to or less than approximately 10 μm. The thickness of the ITO layer 15 is preferably equal to or less than approximately 1 μm. The thickness of the PET layer 16 is preferably approximately 100 to 250 μm.

The FPLs 12 to 16 are pasted to the TFT substrate 10 as shown in FIG. 2. As the FPLs, the ITO layer 15 is provided on one principal surface of the PET layer 16, the electronic ink layer 13 is provided on the ITO layer 15, the lamination adhesive layer 12 is provided on the electronic ink layer 13 and a clear adhesive layer 17 is provided on the other principal surface of the PET layer 16. A release liner 31 is provided on the clear adhesive layer 17.

When the FPLs 12 to 16 are pasted onto the TFT substrate 10, the TPA layer 11 is formed at a predetermined position of the TFT substrate 10 first, and the FPLs 12 to 16 are pasted to the TFT substrate 10 with the lamination adhesive layer 12 oriented toward the TFT substrate 10 side. At this time, the TFT substrate 10 is aligned with the FPLs 12 to 16 so that the FPL connection pad 14 contacts the TPA layer 11. Since the FPLs 12 to 16 are pasted to the TFT substrate 10, the overall thickness is preferably equal to or less than approximately 300 μm taking this step into consideration.

In FIG. 1, the protect sheet 20 is provided on the PET layer 16 of the FPL through the clear adhesive layer 17. Providing this protect sheet 20 makes it possible to improve the mechanical strength of the electronic ink display device and protect the electronic ink layer. The protect sheet 20 is provided with a humidity resistant bather film 18 on one principal surface thereof through a clear adhesive layer 19. When the protect sheet 20 is pasted onto the FPLs 12 to 16, the release liner 31 of the FPL is peeled first and the protect sheet 20 is placed on the FPL in such a way that the humidity resistant barrier film 18 of the protect sheet 20 contacts the clear adhesive layer 17 of the FPL.

The thickness of the clear adhesive layer 17 is preferably approximately 20 to 200 μm. The thickness of the humidity resistant barrier film 18 is preferably equal to or less than approximately 1 μm. The thickness of the clear adhesive layer 19 is preferably approximately 20 to 50 μm. The thickness of the protect sheet 20 is preferably equal to or less than approximately 200 μm. The protect sheet 20 is preferably subjected to anti-glare treatment to reduce the glare of illumination or sunlight. As the material of the protect sheet 20, a PET film, etc., can be used. Furthermore, since the protect sheet 20 is pasted to the FPLs 12 to 16, the overall thickness is preferably approximately equal to or less than 300 μm by taking this step into consideration.

The size of the protect sheet 20 is set to be larger than the sizes of the FPLs 12 to 16. For this reason, both ends of the protect sheet 20 extend from the ends of the FPLs 12 to 16 as eaves. An edge seal 24 is formed in the space between this extending protect sheet 20 and the TFT substrate 10. This edge seal 24 can prevent water from entering the electronic ink layer 13 and improve humidity resistance of the electronic ink display device.

As the material of the edge seal 24, photo-setting resin such as ultraviolet cure resin is preferably used. This edge seal 24 is formed by filling the space between the extending protect sheet 20 and TFT substrate 10 with the photo-setting resin through capillarity. Thus, the use of capillarity allows the space between the extending protect sheet 20 and TFT substrate 10 to be tightly filled with the photo-setting resin. Furthermore, the edge seal 24 is formed by irradiating light into the space between the protect sheet 20 and TFT substrate 10 from the end face side of the FPLs 12 to 16 and thereby curing the resin. Irradiating light from the end face side of the FPLs 12 to 16 allows the photo-setting resin tightly filled in the space between the extending protect sheet 20 and TFT substrate 10 to be irradiated sufficiently with light and allows the photo-setting resin to be cured sufficiently. As a result, it is possible to realize a structure with excellent humidity resistance.

One end of a TCP (Tape Carrier Package) 22 is connected to the TFT substrate 10. A PCB (Printed Circuit Board) 21 is connected to the other end of the TCP 22. Furthermore, a driver IC 23 for driving a display device is mounted at the other end of the TCP 22. In this embodiment, the case has been explained wherein the TCP 22 and PCB 21 are used as the substrates to be connected to the TFT substrate 10, but it is also possible to use a TAB (Tape Automated Bonding) or FPC (Flexible Printed Circuit), etc., as the substrates to be connected to the TFT substrate 10.

Next, the method for manufacturing the electronic ink display device in the above-mentioned configuration will be explained.

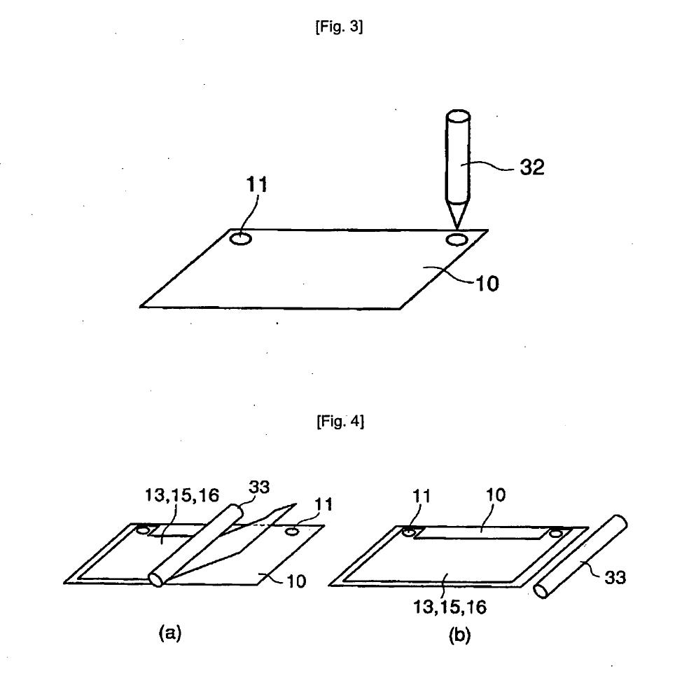

First, as shown in FIG. 3, the TPA layer 11 is formed at a predetermined position of the TFT substrate 10 whose surface has been cleaned. In this case, the TPA layer 11 is dispensed using a dispenser 32 in an aligned state. Next, as shown in FIGS. 4(a), (b), the FPLs are pasted onto the TFT substrate 10. In this case, with the connection pad 14 positioned on the TPA layer 11, the FPLs are pasted onto the TFT substrate 10 at a relatively high temperature (e.g., approximately 100° C.) using a roller 33.

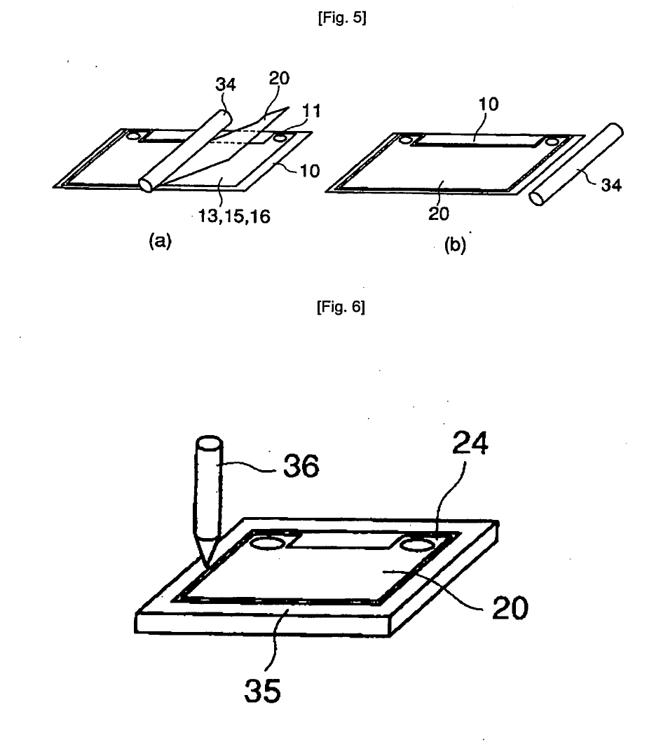

Next, as shown in shown in FIGS. 5(a), (b), the protect sheet 20 is pasted onto the FPL. In this case, the protect sheet 20 is aligned with the FPL and the protect sheet 20 is pasted onto the FPL at a room temperature using a roller 34. After this, by putting the entire substrate in an autoclave at an optimum temperature and pressure, it is possible to remove bubbles remaining in the pasted surfaces. At this time, as shown in FIG. 7, the end of the protect sheet 20 extend from the end of the FPL and a space 37 is formed between the extending protect sheet 20 and TFT substrate 10.

Photo-setting resin (here, ultraviolet cure resin) is applied to the outer surface of the TFT substrate 10 onto which the FPL and protect sheet 20 are pasted as a sealant as shown in FIG. 5(b). At this time, as shown in FIG. 6, the TFT substrate 10 is placed on a base 35 and in this condition, the photo-setting resin is dispensed using a dispenser 36. The photo-setting resin dispensed in this way enters a space 37 between the extending protect sheet 20 and TFT substrate 10 through capillarity and fills the space 37 completely.

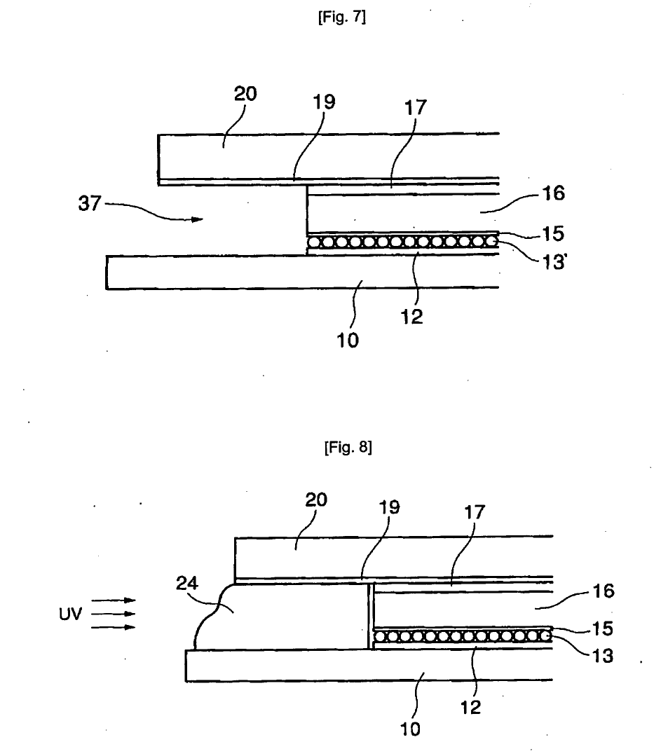

The photo-setting resin charged into the space 37 is cured by being irradiated with light (UV rays) under predetermined conditions. At this time, as shown in FIG. 8, the light is irradiated from the end face side of the FPLs 12 to 16 (direction indicated by arrows in the figure). When a UV-cut type PET film is used as the material of the protect sheet 20, UV rays cannot be irradiated from above the protect sheet 20, and therefore in such a case, it is advantageous to irradiate UV rays from the end face side of the FPLs 12 to 16. This allows the photo-setting resin tightly charged in the space 37 between the extending protect sheet 20 and TFT substrate 10 to be irradiated with sufficient light and allows the photo-setting resin to be sufficiently cured and used as an edge seal 24. After being irradiated with light, the photo-setting resin is heated as required and completely cured. As a result, it is possible to realize a structure with excellent humidity resistance.

In the above-mentioned embodiment, the case has been explained wherein the space 37 between the extending protect sheet 20 and TFT substrate 10 is filled with photo-setting resin using capillarity, but the present invention is not limited to this method. For example, it is also possible to use thermosetting resin instead of photo-setting resin as the edge sealant. Furthermore, as the method of charging the edge sealant, it is also possible to physically press-fit the edge sealant into the space 37 between the extending protect sheet 20 and TFT substrate 10 or print the edge sealant in a pre-determined area of the TFT substrate 10 beforehand.

Thus, the electronic ink display device according to this embodiment is provided with a panel structure with excellent mechanical strength and humidity resistance.

The present invention is not limited to the above-mentioned embodiment, but can be implemented modified in various ways. For example, the size, number and materials in the above-mentioned embodiment are only examples and these can be changed within a range in which the same effects are obtained as appropriate.

1. An electronic ink display device comprising:
a first substrate having display pixels;
a second substrate provided on said first substrate, which includes at least an electronic ink layer; and
a protect substrate provided on said second substrate, which is larger in size than said second substrate and extend from said second substrate,
wherein the space between said protect substrate extending from said second substrate and said first substrate is filled with a sealant.

2. The electronic ink display device as claimed in claim 1, wherein said sealant is charged into the space between said protect substrate extending from said second substrate and said first substrate using capillarity.

3. The electronic ink display device as claimed in claim 1 or 2, wherein said sealant is made of photo-setting resin and is cured through irradiation of light into the space between said protect substrate and said first substrate from the end face side of said second substrate.

4. A method for manufacturing an electronic ink display device comprising:
a step of pasting a second substrate including at least an electronic ink layer to a first substrate having display pixels;
a step of pasting a protect substrate, which is larger in size than said second substrate, to said second substrate so as to extend from said second substrate; and
a step of filling a space between said protect substrate extending from said second substrate and said first substrate with a sealant.

5. The method for manufacturing an electronic ink display device as claimed in claim 4, wherein said step of filling with the sealant is realized in the space between said protect substrate extending from said second substrate and said first substrate using capillarity.

6. The method for manufacturing an electronic ink display device as claimed in claim 4 or 5, wherein said step of filling with the sealant includes a step of curing the sealant through irradiation of light into the space between said protect substrate and said first substrate from the end face side of said second substrate.
